(19) United States
(12) Patent Application Publication
(10) Pub. No.: US 2024/0225127 A1
(43) Pub. Date: Jul. 11, 2024

(54) AEROSOL GENERATING APPARATUS HAVING A PLURALITY OF CARTRIDGES

(71) Applicant: KT&G CORPORATION, Daedeok-gu, Daejeon (KR)

(72) Inventors: In Su PARK, Daejeon (KR); Chan Min KWON, Daejeon (KR)

(73) Assignee: KT&G CORPORATION, Daedeok-gu, Daejeon (KR)

(21) Appl. No.: 18/009,130

(22) PCT Filed: Oct. 14, 2022
(86) PCT No.: PCT/KR2022/015566

§ 371 Date: Dec. 8, 2022

(30) Foreign Application Priority Data
Oct. 28, 2021 (KR) 10-2021-0145593

(51) Int. Cl. A24F 40/57; A24D 1/20; A24F 40/10; A24F 40/20; A24F 40/30; A24F 40/42; A24F 40/46; A24F 40/60; H05B 1/02

(52) U.S. Cl. CPC A24F 40/57; A24D 1/20; A24F 40/10; A24F 40/20; A24F 40/30; A24F 40/42; A24F 40/46; A24F 40/60; H05B 1/0252

(57) ABSTRACT

Provided is an aerosol generating apparatus, including: a housing forming an accommodation space in which an aerosol generating article is accommodated; a heater unit heating the aerosol generating article accommodated in the accommodation space; a first cartridge including a first aerosol forming agent; a second cartridge including liquid nicotine and a second aerosol forming agent; a first cartridge heater unit heating the first cartridge; a second cartridge heater unit heating the second cartridge, and a control unit controlling the aerosol generating apparatus to operate in a set mode of a smoky mode and a smokeless mode.

### TECHNICAL FIELD

The present invention relates to an aerosol generating apparatus including a plurality of cartridges. More particularly, the present invention relates to an aerosol generating apparatus separately including a cartridge including an aerosol forming substrate and a cartridge including nicotine.

This application claims the benefit of priority based on Korean Patent Application No. 10-2021-0145593 filed on Oct. 28, 2021, the entire contents of the present specification are incorporated by reference.

### BACKGROUND ART

In recent years, demand for alternative products that overcome the disadvantages of traditional cigarettes is increasing. For example, there is an increasing demand for apparatuses (e.g., cigarette type electronic cigarette) that generate aerosols by electrically heating a cigarette stick. Accordingly, researches on an electrically heated aerosol generating apparatus and a cigarette stick (or aerosol generating articles) applied thereto are being actively conducted.

Meanwhile, if visible smoke is not generated during smoking, there is an advantage that a user may enjoy smoking without restriction of place or environment. In addition, due to such an advantage, smokeless tobacco products such as snuff, snus, chewing tobacco, and the like have been developed, but the exemplified smokeless tobacco products have a disadvantage that they may not provide a smoking feeling like a combustible cigarette or a heated cigarette stick. On the other hand, there are also smokers who prefer to smoke while generating visible smoke depending on their preferences.

In addition to a difference in preference according to the presence or absence of the visible smoke, there is a difference in preference for an amount of atomization even though the generation of the visible smoke is preferred, and there is also a difference in individual smoker's preferences depending on preference for a tobacco taste with respect to a transfer amount of nicotine.

Accordingly, there is a need for research and development on an aerosol generating apparatus capable of satisfy smokers by providing amounts of atomization and smoking flavors that suit individual's likings because the smokers may directly adjust a difference in cigarette flavor depending on the presence or absence of the visible smoke during smoking, the amount of atomization, and the transfer amount of nicotine.

### PRIOR ART DOCUMENT

### Patent Document

(Patent Document 1) Japanese Patent Laid-Open Publication No. 2021-045149

### DISCLOSURE

### Technical Problem

The present invention provides an aerosol generating apparatus capable of operating in a smoky or smokeless mode according to a smoker's choice and directly adjusting an amount of atomization and a transfer amount of nicotine through various modes according to smoker's preference when operating in the smoky mode.

### Technical Solution

According to a first aspect of the present invention, an aerosol generating apparatus includes:
a housing forming an accommodation space in which an aerosol generating article is accommodated; a heater unit heating the aerosol generating article accommodated in the accommodation space; a first cartridge including a first aerosol forming agent; a second cartridge including liquid nicotine and a second aerosol forming agent; a first cartridge heater unit heating the first cartridge; a second cartridge heater unit heating the second cartridge, and a control unit controlling the aerosol generating apparatus to operate in a set mode of a smoky mode and a smokeless mode.

In an embodiment of the present invention, the aerosol generating article may include a tobacco rod, the tobacco rod may include a first filter segment, a second filter segment, and a cavity segment formed by the first filter segment and the second filter segment, and the cavity segment may be filled with tobacco granules.

In an embodiment of the present invention, the aerosol generating article may further include a filter rod located downstream of the tobacco rod, and the filter rod may include a cooling segment and a mouthpiece segment.

In an embodiment of the present invention, the control unit may operate the heater unit and operate one or more of the first cartridge heater unit and the second cartridge heater unit, in response to a determination that the set mode is the smoky mode.

In an embodiment of the present invention, the smoky mode may be set to any one of a normal mode, a boosting mode, and a composite boosting mode.

In an embodiment of the present invention, the control unit may operate the first cartridge heater unit in response to a determination that the set mode is the normal mode.

In an embodiment of the present invention, the control unit may operate the second cartridge heater unit in response to a determination that the set mode is the boosting mode.

In an embodiment of the present invention, the control unit may operate both the first cartridge heater unit and the second cartridge heater unit in response to a determination that the set mode is the composite boosting mode.

In an embodiment of the present invention, the second cartridge may be a means additionally supplying nicotine so that a total of nicotine transferred for each puff in the boosting mode or the composite boosting mode is constant.

In an embodiment of the present invention, the second cartridge may include 0.1 to 5 wt % of the liquid nicotine and 95 to 99.9 wt % of the second aerosol forming agent.

In an embodiment of the present invention, the control unit may operate only the heater unit in response to a determination that the set mode is the smokeless mode.

In an embodiment of the present invention, the heater unit may be disposed to heat only the cavity segment.

In an embodiment of the present invention, the heater unit, the first cartridge heater unit, and the second cartridge heater unit may be driven in such a way that they are reheated when their temperatures deviate from set ranges after they are initially preheated.

In an embodiment of the present invention, the aerosol generating apparatus may further include a switch disposed on an outer wall surface of the housing, in which the switch is a means setting the smoky mode or the smokeless mode and setting any one of the normal mode, the boosting mode, and the composite boosting mode when the smoky mode is selected.

In an embodiment of the present invention, the aerosol generating apparatus may further include a flow path for directly moving an aerosol generated from the second cartridge to the first filter segment when the aerosol generating apparatus accommodates the aerosol generating article.

### Advantageous Effects

According to the aerosol generating apparatus according to an embodiment of the present invention, it is possible to select a smoky or smokeless mode according to smoker's preference or a smoking place, and it is possible to set various modes having differences in amount of atomization and transfer amount of nicotine by controlling whether or not to heat each of a plurality of cartridges in the smoky mode, such that it is possible to provide an amount of atomization and a smoking flavor that suit an individual's preference.

The aerosol generating apparatus including the plurality of cartridges according to the present invention may transfer a uniform amount of nicotine without difference for each puff by additionally supplying nicotine through a separate cartridge together with an aerosol generating article, and may provide a tobacco taste accordingly.

### DESCRIPTION OF DRAWINGS

FIG. 1 is a diagram schematically illustrating an aerosol generating apparatus when operating in a smokeless mode according to an embodiment of the present invention.

FIG. 2 is a diagram schematically illustrating the aerosol generating apparatus when operating in a smoky mode according to an embodiment of the present invention.

FIG. 3 is a diagram schematically illustrating an aerosol generating article according to an embodiment of the present invention.

FIG. 4 is graphs illustrating amounts of nicotine that the aerosol generating article transfers in Example 1 (normal mode) or Example 2 (composite booster mode) of the smoky mode, according an embodiment of the present invention.

### BEST MODE

Hereinafter, the present invention will be described in more detail.

The terms and words as used herein are not to be construed as being limited to general or dictionary meanings, and are to be construed as meaning and concepts meeting the technical idea of the present invention based on a principle that the present inventors may appropriately define the concepts of terms in order to describe their own inventions in the best manner.

The terms as used herein are used only in order to describe specific embodiments rather than limiting the present invention. Singular forms include plural forms unless the context clearly indicates otherwise. It is to be understood that the terms ‘include’ or ‘have’ as used herein specify the presence of features, numerals, steps, operations, components, parts mentioned in the present specification, or combinations thereof, and do not preclude the presence or addition of one or more other features, numerals, steps, operations, components, parts, or combinations thereof.

The terms “front” and “back” as used herein are defined based on an aerosol flow.

The term “aerosol forming agent” as used herein may refer to a material capable of facilitating the formation of visible smoke and/or aerosol. In the art, the aerosol forming agent may be used interchangeably with the terms such as a moisturizer and a humectant.

The term “aerosol forming substrate” as used herein may refer to a material capable of forming an aerosol. The aerosol may include volatile compounds. The aerosol forming substrate may be solid or liquid. For example, the solid aerosol forming substrate may include a solid material based on tobacco raw materials such as sheet leaf tobacco, cut filler, and reconstituted tobacco, and the liquid aerosol forming substrate may include liquid compositions based on nicotine, tobacco extracts, and/or various flavoring agents. However, the scope of the present disclosure is not necessarily limited thereto. The aerosol forming substrate may further include an aerosol forming agent in order to stably form visible smoke and/or aerosol.

The term “aerosol generating apparatus” as used herein may refer to an apparatus capable of generating an aerosol using an aerosol generating article in order to generate an aerosol that may be directly inhaled into a user's lung through a user's mouth.

The term “aerosol generating article” as used herein may refer to an article capable of generating an aerosol. The aerosol generating article may include an aerosol forming substrate. A representative example of the aerosol generating article may be a cigarette, but the scope of the present disclosure is not limited thereto.

The terms “upstream” or “upstream direction” as used herein may refer to a direction that becomes distant from a user's (smoker's) mouth, and the terms “downstream” or “downstream direction” as used herein are terms refer to a direction that becomes close to the user's (smoker's) mouth. The terms “upstream” and “downstream” are terms used to describe relative positions of elements constituting the aerosol generating article. For example, in an aerosol generating article 20, a tobacco rod 21 is located upstream or in an upstream direction of a filter rod 22, and the filter rod 22 is located downstream or in a downstream direction of the tobacco rod 21.

The term “longitudinal direction” as used herein may refer to a direction corresponding to a longitudinal axis of the aerosol generating article.

Hereinafter, embodiments of the present invention will be described in detail with reference to the accompanying drawings so that those skilled in the art to which the present invention pertains may easily practice the present invention. However, the present invention may be implemented in various different forms, and is not limited to embodiments described herein.

Hereinafter, embodiments of the present invention will be described in detail with reference to the drawings.

An aerosol generating apparatus according to the related art has a limitation in that smokers may directly adjust the presence or absence of visible smoke and an amount of atomization, transfer amounts of nicotine for each puff are not constant, and it is also difficult to adjust the transfer amounts, such that it is difficult to provide an aerosol generating apparatus capable of satisfying various smoking likings of respective smokers.

Accordingly, in order to solve such problems, the present inventors have invented an aerosol generating apparatus capable of allowing a smoker to select a smoky or smokeless mode according to individual's preference and a smoking place, adjusting an amount of atomization and a transfer amount of nicotine by separately controlling whether or not to heat a plurality of cartridges in the smoky mode, and providing a uniform transfer amount of nicotine for each puff when a specific mode is selected.

In an embodiment of the present invention, an aerosol generating apparatus 10 includes: a housing forming an accommodation space in which an aerosol generating article 20 is accommodated; a heater unit 17 heating the aerosol generating article 20 accommodated in the accommodation space; a first cartridge 14 including a first aerosol forming agent; a second cartridge 16 including liquid nicotine and a second aerosol forming agent; a first cartridge heater unit 13 heating the first cartridge 14; a second cartridge heater unit 15 heating the second cartridge 16; and a control unit 12 controlling the aerosol generating apparatus to operate in a set mode of a smoky mode and a smokeless mode.

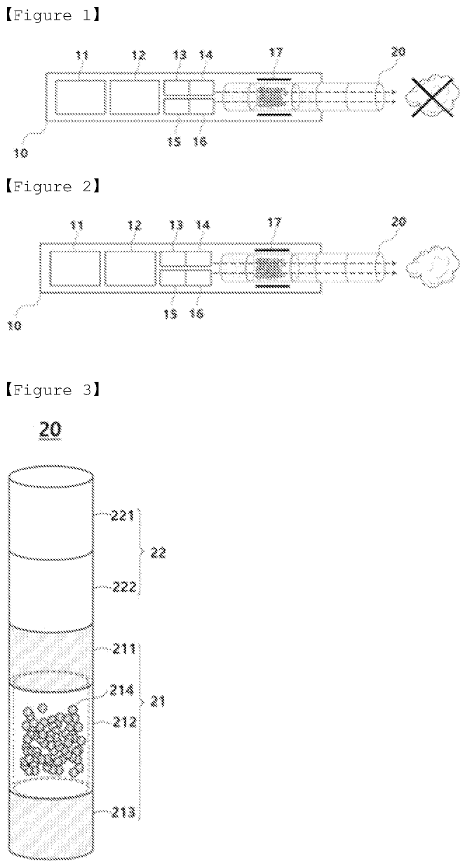

However, only components related to an embodiment of the present disclosure are illustrated in FIG. 1 or FIG. 2. Additionally, those skilled in the art may understand that the aerosol generating apparatus 10 may further include general-purpose components in addition to the components illustrated in FIG. 1 or FIG. 2. For example, the aerosol generating apparatus 10 may further include an input module (e.g., a button, a touchable display, etc.) for receiving a command from a user, or the like, and an output module (e.g., an LED, a display, a vibration motor, etc.) for outputting information such as an apparatus state and smoking information. Hereinafter, each component of the aerosol generating apparatus 10 will be described in detail.

In an embodiment of the invention, the aerosol generating apparatus 10 includes a housing forming an accommodation space in which the aerosol generating article 20 is accommodated. Specifically, the housing may form an appearance of the aerosol generating apparatus 10. The housing may also define the accommodation space for accommodating the aerosol generating article 20. The housing may be preferably made of a material capable of protecting internal components.

In an embodiment of the present invention, the aerosol generating article 20 accommodated in the accommodation space may include a tobacco rod 21, the tobacco rod 21 may include a first filter segment 211; a second filter segment 213; and a cavity segment 212 formed by the first filter segment and the second filter segment, and the cavity segment 212 may be filled with tobacco granules.

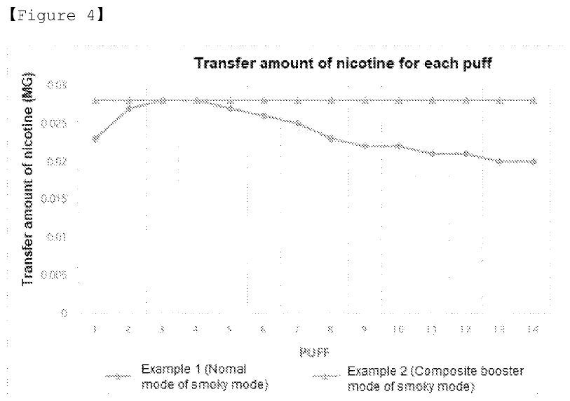

As illustrated in FIG. 3, in an embodiment of the present invention, the tobacco rod 21 may include a first filter segment 211; a second filter segment 213; and a cavity segment 212 formed by the first filter segment and the second filter segment. The tobacco rod 21 is a tobacco rod including a cavity or the cavity segment 212, and may supply tobacco components (or smoking flavor components) such as nicotine as it is heated.

Specifically, the first filter segment 211 may perform functions of forming the cavity segment 212, filtering and cooling an aerosol, and may be located downstream of the cavity segment 212. The second filter segment 213 may perform a function of forming the cavity segment 212 and preventing the tobacco granules from falling off. In addition, the second filter segment 213 may allow the cavity segment 212 to be disposed at an appropriate position within the aerosol generating apparatus 10 when the aerosol generating article 20 is inserted into the aerosol generating apparatus 10, and may prevent the tobacco rod 21 from escaping to the outside and prevent a liquefied aerosol from flowing from the tobacco rod 21 into the aerosol generating apparatus 10 during smoking.

In an embodiment of the present invention, a suction resistance of the first filter segment 211 or the second filter segment 213 may be about 40 mmH₂O/60 mm to 150 mmH₂O/60 mm, and preferably about 50 mmH₂O/60 mm to 80 mmH₂O/60 mm. Within such a numerical range, appropriate suckability may be ensured. In addition, the probability of occurrence of a vortex flow in the cavity segment 212 is increased by the appropriate suckability, and accordingly, an effect of uniformly heating a plurality of tobacco granules 214 may be achieved. In addition, it was confirmed that, when the filter segments are paper filters, an appropriate amount of atomization is ensured within the exemplified numerical range.

In an embodiment of the present invention, each of the first filter segment 211 and the second filter segment 213 may include a paper material.

In an embodiment of the present invention, the first filter segment 211 may include a paper material. In other words, the first filter segment 211 may be formed of a paper filter. The paper material may be preferably arranged in the longitudinal direction in order to smoothly secure an airflow path, but is not limited thereto. The paper material is hardly denatured by heat, and may thus be more easily applied to a tobacco rod portion than cellulose acetate fiber that melts or shrinks when heated to a predetermined temperature or higher.

In an embodiment of the present invention, the first filter segment 211 may include a water-resistant or oil-resistant paper material. When the first filter segment 211 includes the water-resistant or oil-resistant paper material, a problem that smoke components (e.g., moisture and an aerosol forming agent component) included in the aerosol is absorbed while passing through the first filter segment 211, such that a visible amount of atomization is decreased (e.g., a problem that an amount of atomization is decreased in the smoky mode) may be significantly reduced. For example, when the first filter segment 211 includes a general paper material, the above-described smoke components are absorbed due to hygroscopicity of the paper material, such that a visible amount of atomization may be decreased, but when the water-resistant or oil-resistant paper material described above is applied, the absorption of the smoke components described above hardly occurs, such that a problem that the amount of atomization is decreased may be solved.

In an embodiment of the present invention, the first filter segment 211 may be formed of a cellulose acetate filter. In this case, an improvement effect of removal ability of the first filter segment 211 may be achieved.

In an embodiment of the present invention, the second filter segment 213 may include a paper material. In other words, the second filter segment 213 may be formed of a paper filter. The paper material may be preferably arranged in the longitudinal direction in order to smoothly secure an airflow path, but is not limited thereto. The paper material is a material robust against heat, and may significantly alleviate a problem that a fall-off phenomenon of tobacco granules is accelerated due to a phenomenon in which a cellulose acetate fiber is in contact with an internal heating element to melt or shrink when the cellulose acetate fiber is used.

In an embodiment of the present invention, the second filter segment 213 may include a water-resistant or oil-resistant paper material, and as described above in the description of the first filter segment 211, the water-resistant or oil-resistant paper material may significantly reduce a problem that a visible amount of atomization is decreased.

In an embodiment of the present invention, the cavity segment 212 is formed by the first filter segment 211 and the second filter segment 213. The cavity segment 212 is a segment including a cavity, and may be located between the first filter segment 211 and the second filter segment 213. That is, the cavity segment 212 may be formed by the first filter segment 211 and the second filter segment 213.

The cavity segment 212 may be manufactured in various manners. For example, the cavity segment 212 may be manufactured in a form including a tubular structure such as a paper tube or may be manufactured by wrapping a cavity formed by two filter segments with a wrapper made of an appropriate material, but a method of manufacturing the cavity segment 212 is not particularly limited thereto as long as the cavity segment 212 is filled with the tobacco granules.

As illustrated in FIG. 3, in an embodiment of the present invention, the cavity segment 212 may be filled with the tobacco granules 214. In general, the tobacco granules 214 have significantly less contents of moisture and/or aerosol forming agent content than other types of tobacco materials (e.g., leaf tobacco cut filler, sheet leaf, etc.), and thus may significantly decrease generation of visible smoke generation, and accordingly, a smokeless function of the aerosol generating apparatus 10 may be easily implemented. However, a diameter, a density, a filling rate, a composition ratio of constituent materials, a heating temperature, and the like, of the tobacco granules may be various, and may change according to embodiments.

In an embodiment of the present invention, a size of the tobacco granules 214 may be about 15 meshes to 50 meshes, and preferably about 20 meshes to 30 meshes. Within such a numerical range, proper hardness and the manufacturing easiness of the tobacco granules 214 may be ensured, a fall-off phenomenon of the tobacco granules 214 may be minimized, and the probability of occurrence of a vortex flow in the cavity segment may be increased.

In an embodiment of the present invention, the density of the tobacco granules 214 may be about 0.5 g/cm³ to 1.2 g/cm³, and preferably about 0.7 g/cm³ to 0.9 g/cm³. Within such a numerical range, proper hardness and the manufacturing easiness of the tobacco granules 214 may be ensured, and the probability of occurrence of a vortex flow in the cavity segment 212 may be increased.

In an embodiment of the present invention, the hardness of the tobacco granules 214 may be about 70% or more, preferably 80% or more, and more preferably 90% or more. Within such a numerical range, the manufacturing easiness of the tobacco granules 214 may be improved, and a crumbling phenomenon of the tobacco granules 214 may be minimized, such that the manufacturing easiness of the aerosol generating article 20 may also be improved. In an embodiment of the present invention, the hardness of the tobacco granules 214 may be a numerical value measured in accordance with the national standard test method KSM-1802 (“Activated carbon test method”). For details of a hardness measurement method and the meaning of the measured values, the national standard KSM-1802 is referred to.

In an embodiment of the present invention, the filling ratio of the tobacco granules 214 of the cavity segment 212 may be about 80 vol % or less, and preferably about 70 vol % less. Within such a numerical range, the probability of occurrence of a vortex flow in the cavity segment 212 may be increased. In addition, the filling rate of the tobacco granules 214 may be preferably 60 vol % or more in order to ensure an appropriate smoking flavor.

In an embodiment of the present invention, the tobacco granules 214 may include about 20 wt % or less of moisture, and preferably about 10 wt % or less of moisture. Within such a numerical range, the generation of visible smoke may be significantly decreased, and a smokeless function of the aerosol generating apparatus 10 may be easily implemented.

In an embodiment of the present invention, the tobacco granules 214 may include about 10 wt % or less of an aerosol forming agent, preferably about 7 wt %, 5 wt %, 3 wt %, or 1 wt % of an aerosol forming agent. Alternatively, the tobacco granules 214 may not include the aerosol forming agent. Within such a numerical range, the generation of visible smoke may be significantly decreased, and a smokeless function of the aerosol generating apparatus 10 may be easily implemented.

In an embodiment of the present invention, a content of nicotine on a wet basis in the tobacco granules 214 may be about 1.0% to 4.0%, and preferably about 1.5% to 3.5%. Within such a numerical range, an appropriate level of smoking flavor may be ensured.

In an embodiment of the present invention, a content of nicotine on a dry basis in the tobacco granules 214 may be about 1.2% to 4.2%, and preferably about 1.7% to 3.7%. Within such a numerical range, an appropriate level of smoking flavor may be ensured.

In an embodiment of the present invention, the aerosol generating article 20 may be wrapped by at least one wrapper. As a specific example, the aerosol generating article 20 may be wrapped by one wrapper. As another example, the aerosol generating article 20 may be wrapped in an overlapping manner by two or more wrappers. For example, the tobacco rod 21 may be wrapped by a first wrapper, and a filter rod 22 may be wrapped by the second wrapper. In addition, the tobacco rod 21 and the filter rod 22 wrapped by individual wrappers may be coupled to each other, and the entire aerosol generating article 20 may be rewrapped by a third wrapper. If each of the tobacco rod 21 or the filter rod 22 is composed of a plurality of segments, each segment may be wrapped by an individual wrapper. In addition, the entire aerosol generating article in which segments wrapped by individual wrappers are coupled to each other may be rewrapped by another wrapper. At least one hole through which external air is introduced or internal gas is discharged may be formed in the wrapper.

As illustrated in FIG. 3, in an embodiment of the present invention, the aerosol generating article 20 may further include a filter rod 22 located downstream of the tobacco rod 21, and the filter rod 22 may include a cooling segment 222 and a mouthpiece segment 221. The filter rod 22 may be located downstream of the tobacco rod 21 to perform a filtering function for the aerosol. To this end, the filter rod 22 may include a filter material such as paper or a cellulose acetate fiber. The filter rod 22 may further include a wrapper wrapping the filter material.

The filter rod 22 may be manufactured in various shapes. For example, the filter rod 22 may be a cylindrical rod or a tubular rod including a hollow therein. In addition, the filter rod 22 may be a recessed rod. If the filter rod 22 is composed of a plurality of segments, at least one of the plurality of segments may be manufactured in a different shape. In addition, the filter rod 22 may be manufactured to generate flavor. For example, a flavoring solution may be sprayed into the filter rod 22 or a separate fiber to which a flavoring solution is applied may be inserted into the filter rod 22. As another example, the filter rod 22 may include at least one capsule (not illustrated) containing a flavoring solution.

In an embodiment of the present invention, the filter rod 22 may be composed of a plurality of segments.

In an embodiment of the present invention, the filter rod 22 may include the cooling segment 222 and the mouthpiece segment 221. Specifically, the cooling segment 222 may be manufactured in various forms. For example, the cooling segment 222 may be manufactured in forms such as a paper tube, a cellulose acetate filter in which a hollow is formed, a cellulose acetate filter in which a plurality of holes are formed, and a filter filled with a polymer material or a biodegradable polymer material, but is not limited thereto if it may perform an aerosol cooling function. The mouthpiece segment 221 may be, for example, a cellulose acetate filter (i.e., a filter made of a cellulose acetate fiber), but is not limited thereto.

As illustrated in FIG. 1 or 2, in an embodiment of the present invention, the aerosol generating apparatus includes the heater unit 17 heating the aerosol generating article accommodated in the accommodation space. Specifically, when the aerosol generating article 20 is accommodated in the accommodation space of the aerosol generating apparatus 10, the heater unit 17 may heat the aerosol generating article 20 by power supplied from a battery 11.

The heater unit 17 may be configured in various forms and/or manners. As an example, the heater unit 17 may be configured to include an electrically resistive heating element. As another example, the heater unit 17 may include an electrically insulating substrate (e.g., a substrate made of polyimide) and an electrically conductive track, and include a heating element that generates heat as current flows through the electrically conductive track. However, the scope of the present disclosure is not limited to the above-described example, and the heating element may be applicable without limitation as long as it may be heated to a desired temperature. Here, the desired temperature may be preset (e.g., when a temperature profile is pre-stored) in the aerosol generating apparatus or may be set to a desired temperature by a user.

In an embodiment of the present invention, the heater unit 13 may be configured to include a heating element operating in an induction heating manner. Specifically, the heater unit 13 may include an inductor (e.g., an induction coil) for heating the aerosol generating article 20 in the induction heating manner and a susceptor induction-heated by the inductor. The susceptor may be located inside or outside the aerosol generating article 20.

In an embodiment of the present invention, the heater unit 13 may be configured to include a heating element (hereinafter referred to as an “internal heating element”) internally heating the aerosol generating article 20 and a heating element (hereinafter referred to as “external heating element”) externally heating the aerosol generating article 20, or a combination thereof. The internal heating element may be formed in a shape such as a tubular shape, a needle shape, a rod shape, or the like and may be disposed to penetrate through at least a portion of an aerosol generating article 20, and the external heating element may be formed in a shape such as a plate shape or a cylinder shape and may be disposed to surround at least a portion of the aerosol generating article 20. However, the scope of the present disclosure is not limited thereto, and the shape, number, and arrangement of heating elements may be designed in various manners.

In an embodiment of the present invention, the heater unit 17 may be disposed to heat only the cavity segment 212. Specifically, when the filter segment is heated, for example, if the filter segment is a cellulose acetate filter, a problem that a fiber melts or shrinks due to heat occurs, and if the filter segment is a paper filter, a problem that a visible amount of atomization decreases due to an increase in the hygroscopicity of a paper material by heat occurs, and in order to such problems, it is preferable that the heat unit 17 heats only the cavity segment 212. In addition, deformation and release of an adhesive included in the filter may be reduced, a change in physical properties of the filter may be prevented.

As illustrated in FIG. 1 or FIG. 2, in an embodiment of the invention, the aerosol generating apparatus 10 includes the first cartridge 14 including the first aerosol forming agent; and the second cartridge 16 including the liquid nicotine and the second aerosol forming agent.

In an embodiment of the present invention, the first aerosol forming agent may include a material selected from the group consisting of propylene glycol (PG), glycerin (GLY), ethylene glycol, dipropylene glycol, diethylene glycol, triethylene glycol, tetraethylene glycol, and oleyl alcohol, and preferably, may include a material selected from the group consisting of glycerin and propylene glycol, but is not limited thereto.

In an embodiment of the present invention, the second cartridge 16 may include 0.1 to 5 wt % of the liquid nicotine and 95 to 99.9 wt % of the second aerosol forming agent, preferably 0.1 to 3 wt % % of the liquid nicotine and 97 to 99.9 wt % of the aerosol forming agent, and more preferably 0.1 to 1 wt % of the liquid nicotine and 99 to 99.9 wt % of the second aerosol forming agent. When a content of the liquid nicotine is less than 0.1 wt %, an effect of replenishing a transfer amount of nicotine in order to uniformly maintain a total of nicotine transferred for each puff may be insufficient in that an amount of nicotine transferred through the second cartridge is very small. On the other hand, when a content of the liquid nicotine exceeds 5 wt %, there is a problem that throat irritation due to the liquid nicotine increases.

In an embodiment of the present invention, the second aerosol forming agent may include a material selected from the group consisting of propylene glycol (PG), glycerin (GLY), ethylene glycol, dipropylene glycol, diethylene glycol, triethylene glycol, tetraethylene glycol, and oleyl alcohol, and preferably, may include a material selected from the group consisting of glycerin and propylene glycol, but is not limited thereto.

In an embodiment of the present invention, the first cartridge 14 and the second cartridge 16 may include a liquid storage tank and a liquid delivery means. However, the present invention is not limited thereto, and the first cartridge 14 and the second cartridge 16 may further include other components. In addition, the first cartridge 14 and the second cartridge 16 may be manufactured to be detachable and attachable from and to the first cartridge heater unit 13 and the second cartridge heater unit 15, respectively, or may be manufactured integrally with the first cartridge heater unit 13 and the second cartridge heater unit 15, respectively.

In an embodiment of the present invention, the liquid storage tank may store the liquid composition. For example, the liquid composition may be a liquid including a tobacco-containing substance (or a nicotine-containing substance) or may be a liquid including a non-tobacco substance. For example, the liquid composition may include water, a solvent, ethanol, a plant extract (e.g., a tobacco extract), nicotine, a perfume, an aerosol forming agent, a flavoring agent, or a vitamin mixture. For example, the perfume may include menthol, peppermint, spearmint oil, various fruit flavor components, and the like, but is not limited thereto. The flavoring agent is a material that may include a component capable of providing various flavors and savors. The vitamin mixture may be a mixture of at least one of vitamin A, vitamin B, vitamin C, and vitamin E, but is not limited thereto.

In an embodiment of the present invention, the liquid delivery means may deliver the liquid composition stored in the liquid storage tank to the first cartridge heater unit 13 or the second cartridge heater unit 15. For example, the liquid delivery means may be a wick element such as a cotton fiber, a ceramic fiber, a glass fiber, or a porous ceramic, but is not limited thereto.

In an embodiment of the present invention, the aerosol generating apparatus 10 may further include a flow path for directly moving an aerosol generated from the second cartridge 16 to the first filter segment 211 when the aerosol generating apparatus 10 accommodates the aerosol generating article 20. Specifically, the aerosol generated by the transfer of the second aerosol forming agent and the liquid nicotine included in the second cartridge 16 does not pass through the cavity segment 212, and may pass through the first filter segment 211 through the flow path and then move toward the filter rod. Through the flow path, a problem that the total transfer amount of nicotine may not be controlled due to additional transfer of nicotine when the aerosol generated from the second cartridge 16 meets the tobacco granules 214 may be prevented.

As illustrated in FIG. 1 or FIG. 2, in an embodiment of the present invention, the aerosol generating apparatus 10 includes the first cartridge heater unit 13 heating the first cartridge 14; and the second cartridge heater unit 15 heating the second cartridge 16.

In an embodiment of the present invention, the first cartridge heater unit 13 or the second cartridge heater unit 15 may form an aerosol by heating the liquid aerosol forming substrate (e.g., the liquid composition) stored in the first cartridge 14 or the second cartridge 16, respectively. For example, the first cartridge heater unit 13 or the second cartridge heater unit 15 may form an aerosol by heating the liquid composition delivered by the liquid delivery means. The formed aerosol may pass through the aerosol generating article 20 and be delivered to the user. In other words, the aerosol formed by the heating of the first cartridge heater unit 13 or the second cartridge heater unit 15 may move along a airflow path of the aerosol generating apparatus 10, and the airflow path may be configured so that the formed aerosol passes through the aerosol generating article 20 and be delivered to the user. An operation, a heating temperature, and the like, of the first cartridge heater unit 13 or the second cartridge heater unit 15 may be controlled by the control unit 12.

In an embodiment of the present invention, the first cartridge heater unit 13 or the second cartridge heater unit 15 may be, for example, a metal heating wire, a metal heating plate, a ceramic heater unit, or the like, but is limited thereto. In addition, the first cartridge heater unit 13 or the second cartridge heater unit 15 may be formed of, for example, a conductive filament such as a Nichrome wire, and may be disposed in a structure in which it is wound around the liquid transfer means. However, the present invention is not limited thereto. For reference, in the art, the cartridge heater unit and the cartridge may be referred to as terms such as a cartomizer, an atomizer, and a vaporizer.

As illustrated in FIG. 1 or FIG. 2, in an embodiment of the present invention, the aerosol generating apparatus 10 may further include a battery 11. The battery 11 may supply power used to operate the aerosol generating apparatus 10. For example, the battery 11 may supply power to allow the heater unit 17 to heat the aerosol generating article 20, and may supply power required for the control unit 12 to operate.

In an embodiment of the present invention, the battery 11 may supply power required for electrical components such as a display (not illustrated), a sensor (not illustrated), and a motor (not illustrated) installed in the aerosol generating apparatus 10 to operate.

In an embodiment of the present invention, the aerosol generating apparatus 10 may have a smokeless function. In an embodiment of the present invention, the aerosol generating apparatus 10 may operate in a smoky mode or a smokeless mode. For example, the aerosol generating apparatus 10 that operates only in a smokeless mode or operates in a set mode of a smokeless mode and a smoky mode may be provided. Accordingly, the user may use the aerosol generating apparatus 10 without being constrained by a place or an environment, and thus, user's convenience may be significantly improved.

As illustrated in FIG. 1 or FIG. 2, in an embodiment of the present invention, the aerosol generating apparatus 10 includes a control unit 12 controlling the aerosol generating apparatus 10 to operate in the set mode of the smoky mode and the smokeless mode. Specifically, the control unit 12 may control the overall operation of the aerosol generating apparatus 10. For example, the control unit 12 may control operations of the heater unit 17 and the battery 11, and may also control operations of other components included in the aerosol generating apparatus 10. The control unit 12 may control the power supplied by the battery 11, a heating temperature of the heater unit 17, and the like. In addition, the control unit 12 may determine whether or not the aerosol generating apparatus 10 is in an operable state by confirming a state of each of the components of the aerosol generating apparatus 10.

In an embodiment of the present invention, the control unit 12 may be implemented by at least one processor. The control unit may be implemented as an array of a plurality of logic gates or may be implemented as a combination of a general-purpose microcontroller and a memory in which a program executable in the microcontroller is stored. In addition, it may be clearly understood by those skilled in the art to which the present disclosure pertains that the control unit may be implemented as other types of hardware.

In an embodiment of the present invention, the smoky mode may refer to a mode in which the aerosol is generated by the aerosol generating apparatus 10 and visible smoke is also generated. A manner of implementing the smoky mode may be various, and a specific implementation method may change according to embodiments.

In an embodiment of the present invention, the control unit 12 may operate the heater unit 17 and operate one or more of the first cartridge heater unit 13 and the second cartridge heater unit 15, in response to a determination that the set mode is the smoky mode.

In an embodiment of the present invention, the smoky mode may be set to any one of a normal mode, a boosting mode, and a composite boosting mode. Specifically, the smoky mode has an effect of providing with a feeling of satisfaction in smoking to smokers by variously providing smoking flavors and amounts of atomization according to smokers' preferences because it may be selected whether or not to generate visible smoke through the aerosol former included in the cartridge by heating at least one of the first cartridge 14 and the second cartridge 16 for each mode; and whether or not to additional transfer nicotine in addition to nicotine transferred from the aerosol generating article 20 by heating the second cartridge 16.

In an embodiment of the present invention, the control unit 12 may operate the first cartridge heater unit 13 in response to a determination that the set mode is the normal mode. Specifically, the normal mode may be a mode in which the heater unit 17 operates to transfer nicotine included in the tobacco granules in the aerosol generating article 20 and the first cartridge heater unit 13 heats the first aerosol forming agent included in the first cartridge 14 to form an aerosol including visible smoke. An operating temperature of the first cartridge heater unit 13 in the normal mode may be 190 to 290° C.

In an embodiment of the present invention, the control unit 12 may operate the second cartridge heater unit 15 in response to a determination that the set mode is the boosting mode. Specifically, the boosting mode may be a mode in which the heater unit 17 operates to transfer the nicotine included in the tobacco granules in the aerosol generating article 20 and additionally transfer the liquid nicotine included in the second cartridge 16, and the second cartridge heater unit 15 heats the second aerosol forming agent included in the second cartridge 16 to form an aerosol including visible smoke. An operating temperature of the second cartridge heater unit 15 in the boosting mode may be 190 to 290° C.

In an embodiment of the present invention, the control unit 12 may operate both the first cartridge heater unit 13 and the second cartridge heater unit 15 in response to a determination that the set mode is the composite boosting mode. Specifically, in the composite boosting mode, both the first cartridge heater unit 13 and the second cartridge heater unit 15 may operate to form aerosols including visible smoke through the first aerosol forming agent and the second aerosol forming agent, respectively, and a significantly larger amount of atomization may be generated as compared with the normal mode and the boosting mode. In addition, the composite boosting mode may provide a strong tobacco taste according to smoker's preference because nicotine is additional transferred through the liquid nicotine included in the second cartridge 16 as well as a transfer amount of nicotine of the tobacco granules in the aerosol generating article 20.

In an embodiment of the present invention, the second cartridge 16 may be a means additionally supplying nicotine so that a total of nicotine transferred for each puff in the boosting mode or the composite boosting mode is constant. The second cartridge 16 is a cartridge including the liquid nicotine as well as the aerosol forming agent unlike the first cartridge 14, and may be a means additionally supplying the nicotine to increase a transfer amount of nicotine as well as an amount of atomization at the time of forming the aerosol. In addition, the nicotine may be additionally transferred through the second cartridge 16 only until the transfer amount of nicotine reaches a maximum transfer amount of nicotine set in the aerosol generating apparatus 10 through the additional supply of the nicotine, and an operation of the second cartridge heater unit 15 may be stopped after the transfer amount of nicotine reaches the maximum transfer amount of nicotine. The transfer amount of nicotine through the aerosol generating article for each puff may be predicted in advance and adjusted through accumulated profile data or may be adjusted through a value actually measured by a sensor capable of measuring an amount of atomization or a transfer amount of nicotine and included in the aerosol generating apparatus. A transfer amount of nicotine of a liquid cartridge may be adjusted through power applied to a coil.

In an embodiment of the present invention, in the boosting mode or the composite boosting mode, when the transfer amount of nicotine through the aerosol generating article for each puff is smaller than the maximum transfer amount of nicotine set in the aerosol generating apparatus, the control unit 12 may operate the second cartridge heater unit 15 so that a total of the transfer amounts of nicotine reaches the maximum transfer amount of nicotine by additionally transferring the nicotine included in the second cartridge 16.

In an embodiment of the present invention, in the smoky mode, the heater unit 17, the first cartridge heater unit 13, and the second cartridge heater unit 15 may be driven in such a way that they are reheated when their temperatures deviate from set ranges after they are initially preheated. Specifically, in the normal mode, the boosting mode, and the composite boosting mode in the smoky mode, the heater unit 17, the first cartridge heater unit 13, and the second cartridge heater unit 15 are initially preheated, such that heating temperatures of the heater unit 17, the first cartridge heater unit 13, and the second cartridge heater unit 15 may reach the heating temperature ranges, and be then lowered over time to deviate from the heating temperature ranges of the respective modes. In this case, the control unit 12 may operate the heater unit 17, the first cartridge heater unit 13, and the second cartridge heater unit 15 so that the heating temperatures of the heater unit 17, the first cartridge heater unit 13, and the second cartridge heater unit 15 reach the heating temperature ranges of the respective modes.

In an embodiment of the present invention, the smokeless mode may refer to a mode in which the aerosol is generated by the aerosol generating apparatus 10, but the visible smoke is not generated (or a mode in which the generation of the visible smoke is minimized).

In an embodiment of the present invention, the control unit 12 may operate only the heater unit 17 in response to a determination that the set mode is the smokeless mode. Specifically, the control unit 12 may operate only the heater unit 17 in response to a determination that the set mode is the smokeless mode. In this case, the first cartridge 14 or the second cartridge 16 is not heated, only the aerosol generating article 20 is heated, such that generation of the visible smoke may be prevented. Specifically, the liquid stored in the cartridge generates the aerosol including the visible smoke as it is heated, but heating of the liquid is prevented, and thus, generation of the visible smoke may also be prevented.

In an embodiment of the present invention, in the smokeless mode, the heater unit 17 may be heated to maintain a temperature of 270° C. or less, and preferably 240 to 260° C.

In an embodiment of the present invention, the aerosol generating article 20 may be an article filled with the tobacco granules 214. Since the tobacco granules have a very low content of moisture and/or aerosol forming agent, the smokeless mode of the aerosol generating apparatus may be more easily realized when such an aerosol generating article is used.

In an embodiment of the present invention, in the smokeless mode, the heater unit 17 may be driven in such a way that it is initially preheated and then reheated when its temperature deviates from a set range. Specifically, in the smokeless mode, the heater unit 17 is initially preheated, such that a heating temperature of the heater unit 17 may reach a heating temperature range, and may be then lowered over time to deviate from the heating temperature range of the smokeless mode. In this case, the control unit 12 may operate the heater unit 17 so that the heater unit 17 is reheated in order for the heating temperature of the heater unit 17 to reach the heating temperature range of the smokeless mode.

In an embodiment of the present invention, the aerosol generating apparatus may further include a switch disposed on an outer wall surface of the housing, in which the switch may be a means setting the smoky mode or the smokeless mode and setting any one of the normal mode, the boosting mode, and the composite boosting mode when the smoky mode is selected. For example, a button-type switch may be disposed on the outer wall surface of the housing, and three buttons of the normal mode, the boosting mode, and the composite boosting mode of the smoky mode and a button of the smokeless mode are disposed, such that a smoker may set each mode, but the switch is not particularly limited as long as it is a means by which the smoker may easily set each mode.

Hereinafter, examples will be provided in order to help understand the present invention, but the following examples are provided only for easier understanding of the present invention, and the present invention is not limited thereto.

### Manufacturing Example: Manufacturing of Aerosol Generating Article

An aerosol generating article having the same structure as that illustrated in FIG. 3 was manufactured. Specifically, the aerosol generating article has a circumference of about 22 mm, a length of about 48 mm, a first filter segment of about 5 mm, a cavity segment of about 18 mm, a second filter segment of about 5 mm, a cooling segment of about 10 mm, and a mouthpiece segment of about 10 mm. Tobacco granules having a size of about 30 meshes to about 40 meshes and including about 85% of tobacco powders, about 5% of starch, and about 10% of moisture were prepared, and then filled to about 75 vol % in the cavity segment. Creep paper obtained by crimping creep base paper having a paper width of about 150 mm and a basis weight of about 60 mg/m² to about 0.5 to 1.2 mm (that is, paper on which a crimping process is performed) was injected to prepare a paper filter having a suction resistance of about 70 mmH₂O/60 mm, and the prepared paper filter was cut and used as the first filter segment and the second filter segment. In addition, a paper tube was used as the cooling segment, and cellulose acetate was used as the mouthpiece segment.

### Example: Evaluation of Aerosol Transfer Characteristics in Aerosol Generating Apparatus

### Example 1

The aerosol generating article manufactured through the above-described manufacturing example was applied to an aerosol generating apparatus set in a smoky mode or a smoky mode as described herein and separately including ‘a first cartridge including an aerosol forming substrate’ and a ‘second cartridge including an aerosol forming agent and liquid nicotine’ to operate in any one of a normal mode, a boosting mode, and a composite boosting mode under the smoky mode.

A mode of the aerosol generating apparatus was set to the normal mode of the smoky mode, and the aerosol generating apparatus was driven.

### Example 2

The aerosol generating apparatus was driven in the same manner as in Example 1, except that the aerosol generating apparatus was set to the composite boosting mode of the smoky mode.

First, aerosol transfer characteristics generated for each puff by the driving of the aerosol generating apparatus according to Example 1 were represented in Table 1, and transfer amounts of nicotine generated for each puff by the driving of the aerosol generating apparatuses according to Examples 1 and 2 were illustrated in FIG. 4.

Specifically, the driving of the aerosol generating apparatus was performed in a smoking room with a temperature of about 22±2° C. and a humidity of about 60±5%, aerosol generated by each puff was collected while performing a total of 14 puffs under a CRM81 condition, which is a standard measurement method for a liquid e-cigarette inhaled by 55 ml for 3 seconds and waited for 27 seconds, and results were illustrated.

TABLE 1
Normal Mode (Example 1) of Smoky Mode, Unit: mg

| Number | | | | | | |
|---|---|---|---|---|---|---|
| of Puffs | TPM | Tar | Nicotine | PG | Gly | Moisture |
| 1 | 3.84 | 2.70 | 0.023 | 0.46 | 1.90 | 1.12 |
| 2 | 3.75 | 2.61 | 0.027 | 0.38 | 1.96 | 1.11 |
| 3 | 3.86 | 2.75 | 0.028 | 0.38 | 2.09 | 1.09 |
| 4 | 3.87 | 2.83 | 0.028 | 0.39 | 2.13 | 1.01 |
| 5 | 4.05 | 2.92 | 0.027 | 0.42 | 2.21 | 1.09 |
| 6 | 3.98 | 2.95 | 0.026 | 0.42 | 2.25 | 1.00 |
| 7 | 4.05 | 3.03 | 0.025 | 0.45 | 2.37 | 0.99 |
| 8 | 3.95 | 2.91 | 0.023 | 0.45 | 2.35 | 1.02 |
| 9 | 3.96 | 2.98 | 0.022 | 0.46 | 2.34 | 0.96 |
| 10 | 4.14 | 2.78 | 0.022 | 0.50 | 2.40 | 1.33 |
| 11 | 4.13 | 3.18 | 0.021 | 0.51 | 2.58 | 0.93 |
| 12 | 4.15 | 3.23 | 0.021 | 0.52 | 2.42 | 0.90 |
| 13 | 4.28 | 2.56 | 0.020 | 0.55 | 2.65 | 1.70 |
| 14 | 4.38 | 3.39 | 0.020 | 0.57 | 2.74 | 0.97 |
| Total | 56.4 | 40.8 | 0.33 | 6.5 | 32.4 | 15.2 |

*TPM: Total particulate matter/PG: Propylene glycol/Gly: Glycerin

As an experiment result, as represented in Table 1, it was confirmed that in Example 1 in which the aerosol generating apparatus was operated in the normal mode of the smoky mode, a transfer amount of nicotine in 3 to 4 puffs reached a maximum transfer amount of nicotine of 0.028 mg. However, it could be seen that a transfer amount of nicotine for each puff was not constant, such that it was difficult to provide the same tobacco taste for each puff, in that a transfer amount of nicotine in 1 to 2 puffs was 0.023 to 0.027 mg, which is lower than that in 3 to 4 puffs, and a transfer amount of nicotine was gradually decreased as a puff is performed in 5 puffs or more.

On the other hand, as illustrated in FIG. 4, it was confirmed that in Example 2 in which the aerosol generating apparatus was operated in the composite boosting mode of the smoky mode, a transfer amount of nicotine of 0.028 mg was kept constant in 1 to 14 puffs.

Through this, it could be seen that in the composite boosting mode of Example 2, in addition to nicotine transferred by the tobacco granules, a transfer amount of nicotine was additionally replenished through the ‘second cartridge including the liquid nicotine’ until a total of transfer amounts of nicotine reaches the maximum transfer amount of nicotine, such that a certain total of nicotine for each puff was transferred to provide a uniform tobacco taste.

Although the present invention has been described in relation to the above-described embodiments, various modifications and alterations may be made without departing from the spirit and scope of the present invention. Accordingly, these modifications and alterations fall within the scope of the claims as long as they belong to the spirit of the present invention.

### DETAILED DESCRIPTION OF MAIN ELEMENTS

10: Aerosol generating apparatus
11: Battery
12: Control unit
13: First cartridge heater unit
14: First cartridge
15: Second cartridge heater unit
16: Second cartridge
17: Heater unit
20: Aerosol generating article
21: Tobacco rod
22: Filter rod
211: First filter segment
212: Cavity segment
213: Second filter segment
214: Tobacco granule
221: Mouthpiece segment
222: Cooling segment

1. An aerosol generating apparatus, comprising:
a housing forming an accommodation space in which an aerosol generating article is accommodated;
a heater unit heating the aerosol generating article accommodated in the accommodation space;
a first cartridge including a first aerosol forming agent;
a second cartridge including liquid nicotine and a second aerosol forming agent;
a first cartridge heater unit heating the first cartridge;
a second cartridge heater unit heating the second cartridge; and
a control unit controlling the aerosol generating apparatus to operate in a set mode of a smoky mode and a smokeless mode.

2. The aerosol generating apparatus of claim 1, wherein the aerosol generating article comprises a tobacco rod,
the tobacco rod comprises a first filter segment; a second filter segment; and a cavity segment formed by the first filter segment and the second filter segment, and
the cavity segment is filled with tobacco granules.

3. The aerosol generating apparatus of claim 2, wherein the aerosol generating article further comprises a filter rod located downstream of the tobacco rod, and
the filter rod comprises a cooling segment and a mouthpiece segment.

4. The aerosol generating apparatus of claim 1, wherein the control unit operates the heater unit and operates one or more of the first cartridge heater unit and the second cartridge heater unit, in response to a determination that the set mode is the smoky mode.

5. The aerosol generating apparatus of claim 4, wherein the smoky mode is set to any one of a normal mode, a boosting mode, and a composite boosting mode.

6. The aerosol generating apparatus of claim 5, wherein the control unit operates the first cartridge heater unit in response to a determination that the set mode is the normal mode.

7. The aerosol generating apparatus of claim 5, wherein the control unit operates the second cartridge heater unit in response to a determination that the set mode is the boosting mode.

8. The aerosol generating apparatus of claim 5, wherein the control unit operates both the first cartridge heater unit and the second cartridge heater unit in response to a determination that the set mode is the composite boosting mode.

9. The aerosol generating apparatus of claim 5, wherein the second cartridge is a means additionally supplying nicotine so that a total of nicotine transferred for each puff in the boosting mode or the composite boosting mode is constant.

10. The aerosol generating apparatus of claim 1, wherein the second cartridge comprises 0.1 to 5 wt % of the liquid nicotine and 95 to 99.9 wt % of the second aerosol forming agent.

11. The aerosol generating apparatus of claim 1, wherein the control unit operates only the heater unit in response to a determination that the set mode is the smokeless mode.

12. The aerosol generating apparatus of claim 2, wherein the heater unit is disposed to heat only the cavity segment.

13. The aerosol generating apparatus of claim 1, wherein the heater unit, the first cartridge heater unit, and the second cartridge heater unit are driven in such a way that they are reheated when their temperatures deviate from set ranges after they are initially preheated.

14. The aerosol generating apparatus of claim 5, further comprising a switch disposed on an outer wall surface of the housing,
wherein the switch is a means setting the smoky mode or the smokeless mode and setting any one of the normal mode, the boosting mode, and the composite boosting mode when the smoky mode is selected.

15. The aerosol generating apparatus of claim 2, further comprising a flow path for directly moving an aerosol generated from the second cartridge to the first filter segment when the aerosol generating apparatus accommodates the aerosol generating article.
